(19) United States
(12) Patent Application Publication
(10) Pub. No.: US 2010/0229977 A1
(43) Pub. Date: Sep. 16, 2010

(54) COLLAR FOR LAYING CABLES IN PIPE SYSTEMS

(75) Inventors: Helmut Kadrnoska, Wien (AT); Gerhard Reiss, Laxenburg (AT)

Correspondence Address: LERNER GREENBERG STEMER LLP, P O BOX 2480, HOLLYWOOD, FL, 33022-2480, US

(73) Assignee: CABLERUNNER AUSTRIA GMBH & CO. KG, Wien (AT)

(21) Appl. No.: 12/739,790

(22) PCT Filed: Oct. 22, 2008
(86) PCT No.: PCT/AT2008/000384

§ 371 Date: May 28, 2010

(30) Foreign Application Priority Data
Oct. 25, 2007 (AT) A 1744/2007

(51) Int. Cl. F16L 9/00; H02G 1/08; F16L 3/08

(52) U.S. Cl. 137/561 R; 248/49; 254/134.3 R

(57) ABSTRACT

A collar with a collar body for laying cables in pipe systems. A first section of a guide part, which is formed by a pipe and has a guide opening for a cable, adjoins a subregion of a circumferential edge of the collar body. The guide part is bent by way of a further section, which continues the first section, into the interior of the collar body, in particular towards the inner wall surface of the collar. The further section extends in the direction of the other circumferential edge of the collar body. A second guide part, which has a guide opening for the cable and is formed, in particular, by a curved pipe, is pivotally mounted on the first section of the adjoining first-mentioned guide part.

The invention relates to a collar according to the preamble of claim 1 and to a method according to the preamble of claim 11.

Methods and collars of this type are used primarily for laying cables, in particular, in municipal pipe networks or waste water pipe systems. A comparable method may also be used for laying cables in pipelines of ventilation systems.

According to the prior art, in most cases cables are laid in cunettes, which ordinarily run below streets. This technology allows a practically unlimited number of cables to be laid in a single pass; however, a significant disadvantage is that this causes dust and noise emissions along with impediments to traffic and high costs. Moreover, the construction of cunettes in a municipal area is not always possible due to a shortage of space.

A known alternative option involves the laying of cables in already existing structures that offer a hollow space, such as sewer and storm drain systems or ventilation systems. This involves substantial problems in that in the area of branch-offs within the systems, the laid cable must not be allowed to impede the waste water. However, at branch-off points cables normally run perpendicular to the direction in which they are laid inside the pipe or channel, or crosswise to the direction of the pipe, which can cause blockages. Additionally, the laying and branching off of cables in the area of pipe laterals is problematic and costly, with the securing of the cable presenting a particular difficulty.

The object of the invention is to solve the aforementioned problems and enable a simple, cost-effective, rapid and secure laying of cable using a stable collar with a simple structure, and to enable blockage-free operation of a cable line in a pipe system, preferably a waste water pipe system.

This object is attained according to the invention with a collar of the type specified above, having the features of the characterizing portion of claim 1, and with a method of the type specified above, having the features of the characterizing portion of claim 11.

The solution of the invention offers the advantage that the structurally simple collar can be installed in a pipe system without great expense, and can be easily mounted on the interior of a pipe within the pipe system; the cable to be run can also be easily inserted and takes up only a very small portion of the pipe cross-section in the area of the pipe lateral. The taut cable run that is achieved allows twisting and blockages to be avoided.

The structure of the collar of the invention allows the collar to be inserted, in particular using a cable laying robot, through a main pipe of a waste water pipe system in the area where a secondary pipe is joined to the main pipe, and allows the collar body to pivot about the pivotable guide piece, which during insertion is held in place, into the secondary pipe. The cable that is laid in the secondary pipe is held in place by the collar. The cable to be laid can be run in the main pipe within a cable conduit, with the pivotable guide piece producing the connection between the cable conduit and the collar or the adjoining guide piece. In this manner, the cable to be laid can be run through the cable conduit, through the pivotable guide piece and through the adjoining guide piece, from the main pipe into the secondary pipe, while remaining protected. In the secondary pipe, the cable can be run without its own protective sheath or protective casing to a house service line or to the predetermined outlet point, which can be in a house, or the cable can be guided out of the secondary pipe.

The cables to be laid involve primarily cables containing optical fiber lines.

A stable mounting of the collar body in the secondary pipe is obtained by fastening or gluing or welding the additional section onto the inner wall surface of the collar body.

A stable and easily produced structure for the guide pieces can be obtained by pivotably connecting the end of the first section to the end of the pivotable guide piece via a connecting or bearing piece, or by configuring the end of the first section and the end of the pivotable guide piece to form a rocker pivot, or by pivotably connecting these to one another to form a shared pivoting axis, or by configuring the guide recess of the pivotable guide piece as a continuation of the guide recess of the adjoining guide piece, the first section, the connecting or bearing piece and/or the rocker pivot, in particular having the same cross-sectional area, and/or by configuring the adjoining guide piece and the pivotable guide piece and the connecting or bearing piece and/or the rocker pivot to define a continuous recess for the cable and/or embodying these as pipes having the same cross-section or the same inside diameter, and/or by configuring the first section of the adjoining guide piece to extend over an angle of 60° to 100°, preferably 70° to 90°, along the circumferential edge of the collar body and/or to be connected along this area to the circumferential edge, and/or by configuring the connecting or bearing piece and/or the rocker pivot and the additional section to rest on the collar body spaced from one another at a circumferential distance of 80° to 100°, preferably 85° to 95°, and/or by configuring the pivoting axis between the adjoining guide piece and the pivotable guide piece at the location of the connecting or bearing piece or the rocker pivot to form an angle of ±10° with a tangent to the circumference of the collar body and/or to the circumferential edge.

This also results in a stable structure and an advantageous mounting of the collar. Above all, this allows the cable to be run along the base area of the secondary pipe, while the area in which the adjoining guide piece and the pivotable guide piece can be rotated or pivoted relative to one another rests along the lateral wall area of the secondary pipe. This also results in geometrically simple ratios, or a short path for running the cable from the collar into the main pipe.

The simply structured collar can be easily inserted into the pipe system if the collar body is provided in the form of a flexible, rollable and/or deformable band, which is curved in its longitudinal extension, in particular in a circular shape, wherein the collar body may optionally be split vertically, with the unattached ends of the collar body or band overlapping or extending beyond one another, and/or the adjoining guide piece and/or the pivotable guide piece are each formed by a curved pipe, in particular each as a single piece, and/or the additional section of the adjoining guide piece runs perpendicular to the two circumferential edges of the collar body in the area of the end that faces away from the pivotable guide piece, and optionally terminates flush with the circumferential edge or projects beyond it. The collar conforms well to the interior wall of the pipe, in particular, to give the waste water the least possible amount of contact surface.

It is advantageous for the collar body to have two ends that can be displaced in relation to one another and/or connected to one another, and for the adjoining guide piece to be positioned opposite the two ends of the collar body or band when connected, wherein the collar body, especially in the area of its two ends, optionally supports cooperating connecting elements and/or latching elements or radially continuous recesses and projections which extend from said collar body and conform to the recesses, and with which the unattached ends are connected to one another, thereby defining the circumference of the collar body. This enables a simple insertion and secure mounting of a collar having a decreased outer circumference into the pipeline system.

The invention comprises not only a collar for insertion into a pipe system, but also a pipe system inside which are cables, which are inserted with the collar of the invention into the pipe system in a manner specified in the invention, and mounted on the walls of the pipes. In the assembly of the invention, it is provided that the cable is inserted, especially without interruption, starting from the main pipe and running through the collar, which is positioned in the connection or branch-off area of the main pipe and the secondary pipe, into the secondary pipe, wherein the cable is run through the two guide pieces and the connecting or bearing piece and/or the rocker pivot that connects the two guide pieces, wherein the cable is optionally secured and/or clamped in the adjoining guide piece and/or in the pivotable guide piece. These characterizing features offer the advantage of a cable laid in a pipeline system, which can be quickly and easily laid, held in place by a collar, or which is held securely by the collar during operation. The cable and the collar are inserted into the pipe by means of cable laying robots, which transport the collar, together with the cable fed into the guide pieces of the collar, to the appropriate location in the pipe, and also make sure the cable is appropriately fastened to the inner wall of the pipe.

To offer the waste water the least possible amount of contact surface, it is provided that the collar and/or the collar body, in particular the entire unit, is located in the secondary pipe, wherein the circumferential edge of the collar body, against which the adjoining guide piece is fastened, faces the main pipe, and/or the first section of the adjoining guide piece and/or at least the area of the pivotable guide piece that is close to the connecting or bearing piece or the rocker pivot, and/or the connecting or bearing piece or the rocker pivot are positioned in the area of or in front of the intersecting edge of the main pipe with the joined secondary pipe, and/or the outer wall of the collar body, in particular over its entire width, rests against the inner wall surface of the secondary pipe, or is fastened or glued to this inner wall surface. This also serves to significantly diminish mechanical damage to the collar. The collar is precisely positioned, however at the same time, the collar can be pivoted precisely and easily by means of a robot.

The collar can be mounted by means of the elastic spreading forces of the collar body or the unattached ends of the collar, or by gluing the collar body to the inner walls of the pipe. Expediently, the length of the band that forms the collar body corresponds to 50 to 150%, preferably 100 to 130%, of the inner circumference of the secondary pipe, and/or the outside of the collar body is coated with an adhesive material, which prevents the collar body from shifting axially and/or circumferentially in the secondary pipe, and/or the curvature of the pivotable guide piece is configured to conform to the curvature of the interior cross-section of the main pipe or corresponds to said curvature, and/or the length of the pivotable guide piece is approximately 15 to 25% of the inner circumference of the main pipe.

For the precise and protected laying of cable in pipe systems, it is advantageous for the cable to run within a cable conduit inside the main pipe, and to lead from this conduit into the pivotable guide piece in the area in which the secondary pipe connects with the main pipe, and/or for the pivotable guide piece to be embodied as a cable coupler, with its end that faces away from the adjoining guide piece being displaceably guided on or in the cable conduit or connected to it, and/or for the cable conduit to be located in the top area of the main pipe, and/or, if the collar is inserted into the secondary pipe, for the connecting or bearing piece or the rocker pivot to be laid between the pivotable guide piece and the adjoining guide piece in the area of the half height of the secondary pipe, and for the additional section of the adjoining guide piece to extend in the base area of the secondary pipe. When transferring the cable that has been laid in the main pipe to the secondary pipe, the branched-off cable is thereby held securely in place, and during operation it is guided into the secondary pipe, especially protected against waste water.

When inserting the collar into the secondary pipe, it is advantageous for the cable to be inserted into the adjoining guide piece and the pivotable guide piece of the collar, for the cable leading from the additional section to be inserted or forced or drawn into the secondary pipe via the main pipe, for the collar to be inserted through the main pipe until its circumferential edge with the connecting or bearing piece or the rocker pivot comes to rest in the area upstream of the intersecting edge of the acute angle of the junction of the secondary pipe with the main pipe, and for the collar body to be positioned upstream of the junction opening of the secondary pipe, wherein, especially when the area of the pivotable guide piece and/or of the connecting or bearing piece that is near the first section will be secured, in particular, at the half height of the secondary pipe, the collar body, with the cable run in it, pivots in relation to the pivotable guide piece, which remains stationary, and is inserted into the secondary pipe, and the collar is secured in the secondary pipe. It is possible for the collar to approach the secondary pipe from either side of the main pipe, and to then be positioned in the secondary pipe. In this connection, the running or drawing of the cable must be considered, namely that a corresponding path of the cable, starting from a cable conduit located in the upper area of the main pipe, or starting from a cable shaft that opens into the main pipe, through the guide pieces and the collar body, into the secondary pipe to the house service line is created, without the cable twisting around the collar. To this end, it is advantageous for the collar to be inserted into the main pipe from the side of the acute angle of the junction of the secondary pipe, wherein the cable leading from the adjoining guide piece and to be fed into the secondary pipe is located in front of the collar body, and the cable that leads into the pivotable guide piece is inserted behind into the main pipe, and/or, if the collar body is inserted into the main pipe from the side of the obtuse angle of the junction of the secondary pipe, it is advantageous for the circumferential edge with the two guide pieces to be inserted in front in the direction of insertion and for the cable that leads away from the additional section of the adjoining guide piece to be laid or inserted in front into the pipe, outside of the collar body and/or past the collar body, and for the cable leading away from the pivotable guide piece to be laid or run in front in the direction of insertion, and/or, during insertion of the collar body, for the pivotable guide piece to act as a cable coupler and to be connected at its end area that is distant from the collar to the cable conduit, and displaced along or in the cable conduit located in the main pipe, in particular, in its top area, and/or, during insertion of the collar in the main pipe and/or during pivoting of the collar into the secondary pipe, for the additional section of the adjoining guide piece to be guided and/or positioned in the base area of the pipe.

In this case, the collar is displaced lengthwise on the cable conduit, together with the pivotable guide piece embodied as a cable coupler, wherein the pivotable guide piece is connected to the cable conduit, i.e., either clipped to the cable conduit or run in a longitudinally extending opening in the cable conduit so as to be displaceable. The collar can be dependent upon the cable conduit and can be moved by a robot in the lengthwise direction of the conduit, wherein the cable is drawn along in an appropriate manner, or has already been inserted in advance into the main pipe and into the secondary pipe in an appropriate manner.

With the collar of the invention and the process of the invention, cable can be laid and the collar can be inserted despite the ever-present water resistance. The collar of the invention further offers a small contact surface for objects carried along in the waste water, thereby largely preventing mechanical damage to the cable runs. Because it is possible to configure the collar as small for insertion, or to decrease its circumference, the cable laying process can be automated using cable robots, even in narrow pipe systems.

It is advantageous for mirror-image collars to be used in secondary pipes that branch off from the same side of the main pipe but in opposite directions.

In what follows, the invention will be specified in greater detail in reference to the set of drawings:

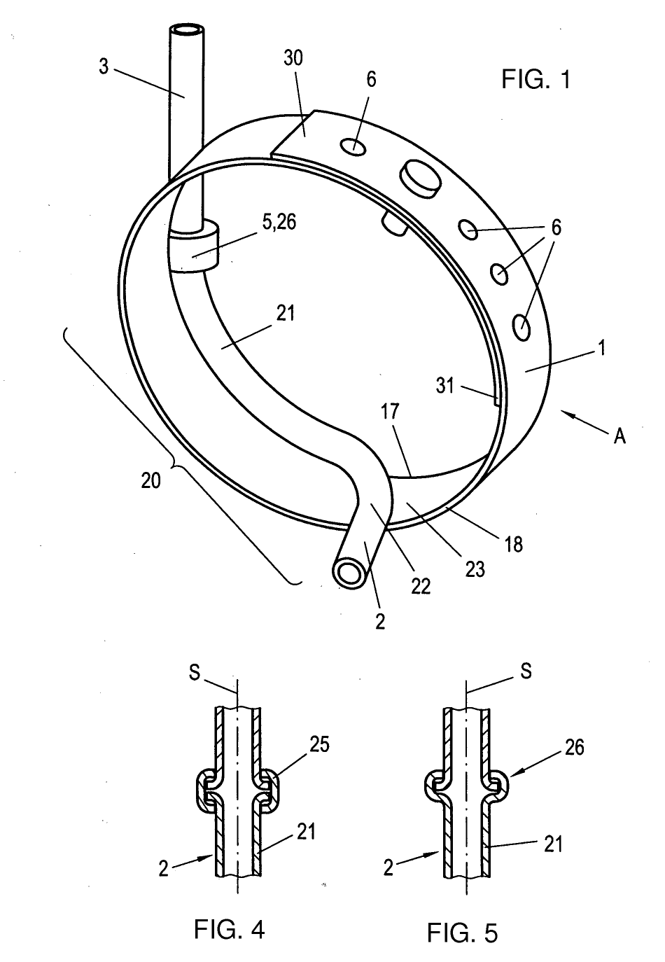

FIG. 1 shows the collar.

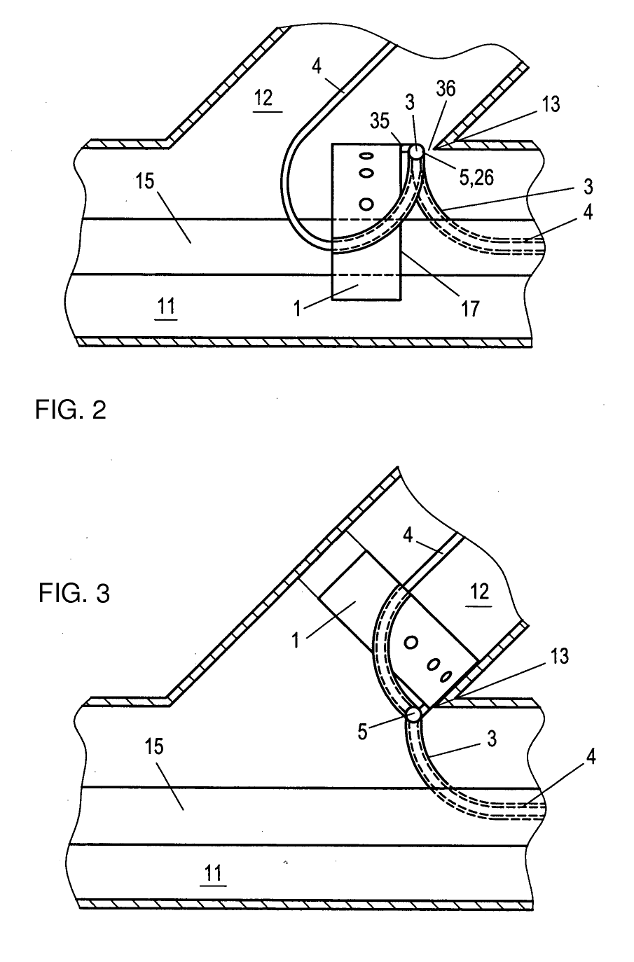

FIG. 2 shows a schematic, horizontal section of the collar in a main pipe, before pivoting into a secondary pipe that branches off from this main pipe.

FIG. 3 shows a schematic horizontal section of the collar after pivoting into a secondary pipe that branches off from a main pipe, in a secured position.

FIGS. 4 and 5 show options for the pivotable connection of an adjoining and a pivotable guide piece.

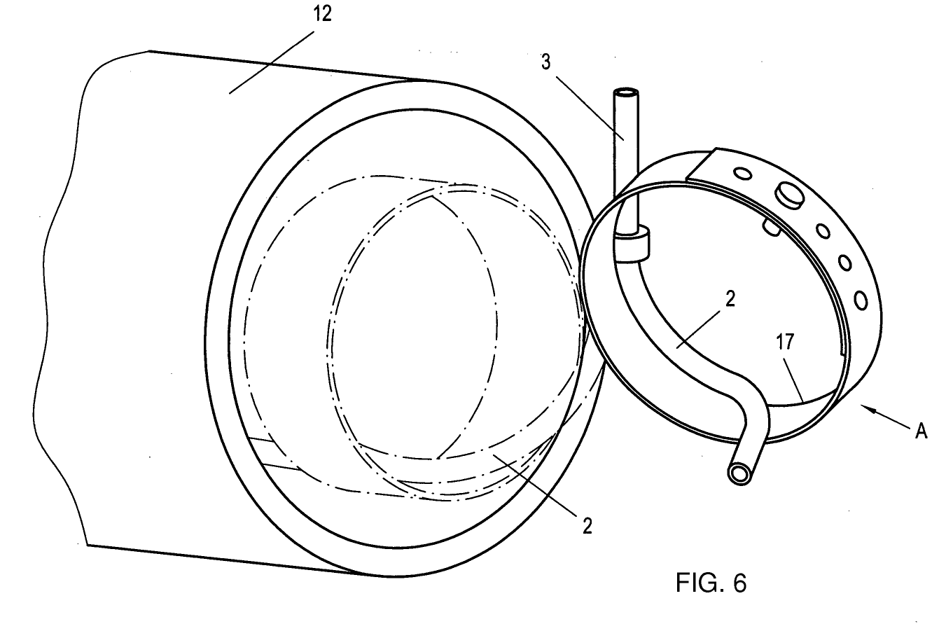

FIG. 6 shows a schematic view of the pivoting of a collar into a secondary pipe about a pivoting axis, which extends through the pivotable guide piece and the end area of the additional section of the adjoining guide piece.

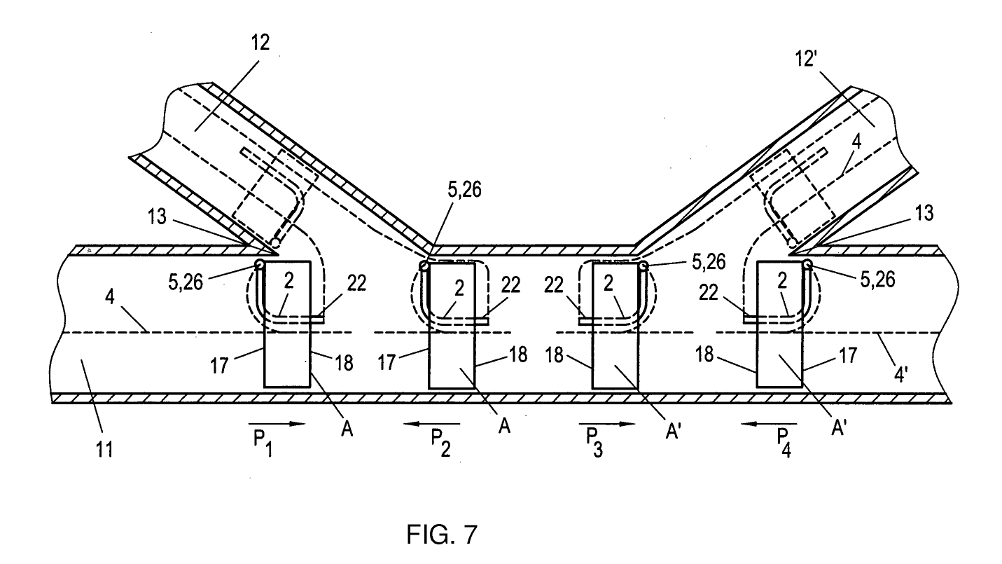

FIG. 7 shows a schematic view of the insertion of mirror-image collars.

A collar of the invention according to FIG. 1 is used to run or mount cables in pipe systems, for example in waste water or ventilation systems. The pipe system, as is apparent in FIGS. 2 and 3, comprises a main pipe 11 and at least one secondary pipe 12 that joins with the main pipe 11. The secondary pipe 12 joins with the main pipe 11 either at a right angle or at an acute angle, in such a way that between the main pipe 11 and the secondary pipe 12 an acute angle is formed on one side of the junction and an obtuse angle is formed on the other side. In the area of the acute angle, an intersecting edge 13 is formed between the main pipe 11 and the secondary pipe 12. The angle of the junction is significant to the invention.

In the main pipe 11, in most cases a cable conduit 15 is mounted on the upper interior side, on which, for example to the side, objects, in particular cable or cable couplers, can be inserted or guided.

The collar A shown in FIG. 1 comprises a collar body 1 in the form of a band, which is especially curved in the shape of a circle along its lengthwise extension. The collar body 1 is usually made of plastic or metal, and has a high degree of elasticity and break resistance. It has also proven advantageous for the collar body to be resistant to aggressive liquids or to be coated on its surface with a durable material. On its outer wall surface, the collar A can have an adhesive coating, which is made of a material that prevents resistance to displacement of the collar [sic—Translator] axially or azimuthally in the secondary pipe 12 when acted upon by a force directed radially outward. Adhesive force and stability can be influenced by the width of the band that forms the collar body 1. The length of the band that forms the collar body 1 conforms to the inner circumference of the secondary pipe 12 and is advantageously greater than half the circumference of the pipe 12.

The collar body 1 can be embodied as continuous or as a single piece, wherein its circumference conforms to the inner circumference of the secondary pipe 11 [sic—Translator]. To allow this collar body to be inserted, however, it can be elastically deformed or its circumference can be decreased, to allow the collar body 1 to be inserted more easily through the main pipe 11 into the secondary pipe 12. Advantageously, the collar body 1 can be embodied as discontinuous, with the length of the band that forms the collar body 1 being 50 to 150%, preferably 100 to 130%, of the inner circumference of the secondary pipe 12. In this case, the collar body 1 can either rest against the inner wall surface of the secondary pipe 12 by virtue of its elasticity or a level of pretension instilled in the band, or the collar body can be clipped on. As long as the length of the band exceeds the inner circumference of the secondary pipe 11 [sic—Translator], it can be expediently provided that the the [sic—Translator] split band supports connecting elements that cooperate with one another at both of its ends 30, 31, for example latching elements or radially continuous openings and projections that conform to said openings, which connect the unattached ends 30, 31 to one another, thereby defining the circumference of the collar body 1. Connecting elements of this type can be used to decrease the circumference of the collar body during insertion through the main pipe 11, to facilitate insertion. In the secondary pipe 12, these connecting elements can be used to connect the unattached ends 30, 31 in such a way that a widened collar body 1 is placed or pushed against the inner wall surface of the secondary pipe and secured in this position. This can be accomplished, for example, by latching the two unattached ends 30, 31.

FIG. 1 shows a collar, in which along a partial area 20 of a circumferential edge 17 of the collar body 1, a first section 21 of a guide piece 2 embodied as a pipe rests, with a guide recess for a cable 4. This guide piece is bent with an additional section 22 that is a continuation of this first section 21, into the interior space of the collar body 1, in particular, against the inner wall surface 23 of the collar A. The additional section 22 extends in the direction of the other circumferential edge 18 of the collar body 1. A guide piece 3, which has a guide recess for the cable 4 and is embodied, in particular, as a curved pipe, is pivotably mounted on the first section 21 of the adjoining guide piece 2.

The adjoining guide piece 2 is made of metal or plastic and has the shape of a curved pipe. The adjoining guide piece 2 extends along the circumferential edge 17 of the collar body 1 approximately parallel to the edge 17, specifically from the inner wall surface 23 of the collar body 1 to the edge surface of the collar body 1. The adjoining guide piece 2 is glued or welded to the collar body 1. The adjoining guide piece 2 extends from the circumferential edge 18 in the direction of the circumferential edge 17 opposite it, crosswise to the longitudinal direction of the band which forms the collar body 1, rests against the collar body 1, and is curved toward the circumferential edge 17, wherein when the adjoining guide piece 2 reaches the circumferential edge 17, it is directed toward the outer or narrow side of the collar body 1.

The extension of the adjoining guide piece 2 in the direction of the longitudinal extension of the band that forms the collar body 1 corresponds to approximately one-fourth the circumference of the collar body 1 in its functional state, or approximately one-fourth of the inner circumference of the secondary pipe 12.

The first section 21 of the adjoining guide piece 2 extends over an angular area of 60 to 100°, preferably 70 to 90°, along the circumferential edge 17 of the collar body 1, or is connected to the circumferential edge 17 along this area.

At the end of the adjoining guide piece 2, which lies near the circumferential edge 17, the pivotable guide piece 3 is attached or articulated.

The guide recess of the pivotable guide piece 3 is a continuation of the guide recess of the adjoining guide piece 2 or the first section 21 or the connecting or bearing piece 5 or the rocker pivot 26, in particular, having the same cross-sectional area. The adjoining guide piece 2 and the pivotable guide piece 3 or the connecting or bearing piece 5 or the rocker pivot 26 delimit a continuous recess for the cable 4, or are embodied as pipes having the same cross-section or the same inside width.

The adjoining guide piece 2 and/or the pivotable guide piece 3 can each be embodied as a curved pipe, in particular each as a single piece.

The adjoining guide piece 2 can be positioned in the area of the collar body 1 which is located opposite the opening area 25 of the collar body 1 or the unattached ends 30, 31 of the collar body 1 or band, which can be displaced in relation to one another or connected to one another.

For the functional positioning of the collar A, it is advantageous for the connecting or bearing piece 5 or the rocker pivot 26 and the additional section 22 to be spaced from one another at a circumferential distance of 80 to 100°, preferably 85 to 95°, on the collar body 1.

The pivoting axis S extends between the adjoining guide piece 2 and the pivotable guide piece 3 at the point of the connecting or bearing piece 5 or the rocker pivot 26, at an angle of ±10°, with a tangent T, shown in FIG. 2, on the periphery of the collar body 1 or the circumferential edge 17.

As is shown in FIG. 2, the rocker pivot 26 or the connecting or bearing piece 5 can be spaced a slight distance 35 from the circumferential edge 17, to compensate for the distance 36 of these components 5, 26 from the end of the intersecting edge 13, so as to allow the entire collar A, along with the adjoining guide piece 2, to be pivoted into the secondary pipe 12.

It is further provided that the end of the first section 21 is pivotably connected to the end of the pivotable guide piece 3 via a connecting or bearing piece 25, or that the end of the first section 21 and the end of the pivotable guide piece 3 form a rocker pivot 26, or are connected so as to be pivotable in relation to one another about the shared pivoting axis S.

To ensure the pivoting of the two guide pieces 2, 3 in relation to one another, various embodiments of rocker pivots can be used which permit a passable opening between the two guide pieces 2, 3. One simple option for forming a rocker pivot between the two guide pieces 2, 3 is to form internal threading on one of the two guide pieces 2, 3, and external threading that matches the first on the other guide piece 2, 3. The pivotable guide piece 3 is placed on the adjoining guide piece 2 that is connected to the collar body 1 by rotating the pivotable guide piece 3, in which case the two guide pieces 2, 3 are not securely screwed to one another, but remain pivotable in relation to one another.

Another option for enabling the pivotability or mutual rotatability of the two guide pieces 2, 3 consists in using an additional connecting piece 25, embodied, for example, as a ring with a groove, as shown in FIG. 4, which is positioned in the area at which the ends of the two guide pieces 2, 3 meet, around these ends, wherein on the periphery of each of the pipes that form the guide pieces 2, 3, a projecting ring is provided, which rings are introduced into the groove(s) in the connecting piece 5.

According to FIG. 5, a rocker pivot 26 can be created in which an an [sic—Translator] annular projection is formed at one end of one of the two guide pieces 2, 3, which projection is rotatably held by an inner peripheral groove in the respectively other guide piece 3, 2.

To facilitate the securing of the collar body 1 on the secondary pipe 12 or to enable the transport of the collar body 1 through the main pipe 11 or the secondary pipe 12, two or more recesses or holes 6 can be formed in the collar body 1, in particular, in the ends 30, 31 of the band. Once the collar A has been rolled up, it can be held in position by inserting a corresponding object through the two holes 6, thereby securing the collar A preliminarily in its locked extension. To adjust the collar A to different pipe cross-sections, multiple holes 6 can also be provided, each located in the area of the unattached ends 30, 31 of the band that forms the collar body 1.

Around the secure seating of a cable 4 to be inserted into the pipe system inside the guide pieces 2, 3 are squeezed or pressed onto the inserted cable 4 [sic—Translator]. The cable is thereby secured in its position in relation to the collar A.

To insert a cable into a pipe system using the collar of the invention, the cable 4 is inserted into the adjoining guide piece 2 and the pivotable guide piece 3 of the collar A, as shown in FIG. 6. The cable 4 leading from the additional section 22 is then inserted via the main pipe 11 into the secondary pipe 12, in particular, forced or drawn. The collar A is inserted through the main pipe 11, until the circumferential edge 17 with the connecting or bearing piece 5 or with the rocker pivot 26 comes to rest in the area of the main pipe 11 upstream of the intersecting edge 13 of the acute angle of the junction of the secondary pipe 12. While the area of the pivotable guide piece 3 and/or the connecting or bearing piece 5 or the rocker pivot 26 that is near the first section 21 is held securely in place, in particular, at the half height of the secondary pipe 12, the collar body 1, with the cable 4 guided inside it, is pivoted in relation to the pivotable guide piece 3, which remains stationary, and is inserted into the secondary pipe 12. The collar A can then be secured in the secondary pipe 12, for example with screws.

The method of the invention comprises two different options. In principle, it is possible for the collar A to be inserted from the side of the acute angle of the junction of the secondary pipe 12 with the main pipe 11. In this case, the cable strand 4 to be guided into the secondary pipe 12 is inserted in front of the collar body 1, and the cable strand 4 that leads into the pivotable guide piece 3 is inserted into the main pipe 11 behind it. Alternatively, if the collar body 1 is inserted into the main pipe 11 from the side of the obtuse angle of the junction of the secondary pipe 12, the circumferential edge 17 enters first in the direction of insertion, and the cable strand 4 that leads from the additional section 22 of the adjoining guide piece 2 is laid or guided first into the pipe 11 outside of the collar body 1 or along the body, wherein the cable 4 that leads from the pivotable guide piece 3 is laid or guided in first in the direction of insertion. The cable 4 is thus laid through the main pipe 11 and the secondary pipe 12 and fed through both guide pieces 2, 3. In principle, the cable 4 could also be inserted from the direction opposite this insertion direction. For this reason, the cable 4 is shown as continuous in the main pipe 11 with respect to the collar A, A′.

The fundamental prerequisite for the two processes is that the respective ends of the cable 4 have been inserted or forced into the main pipe 11 or into the secondary pipe 12, as this makes insertion of the collar considerably easier.

The main difference between the two processes consists in that, in the first case, the collar A is inserted in the direction of the junction from the side of the main pipe 11 that is closer to the acute angle; in the other case, the collar A is inserted in the direction of the junction from the side of the main pipe 11 that is closer to the obtuse angle. Comparable conditions are present if the collar A will be installed in a pipe 11 that joins the main pipe 11 at a right angle.

During insertion, the collar A can have a decreased circumference or can be rolled up, as shown in FIG. 6; optionally, a securing pin can be inserted through each of two holes 6 in the ends 30, 31 of the collar body A.

It is advantageous for the curvature of the pivotable guide piece 3 to match or correspond to the curvature of the inner cross-section of the main pipe 11. With respect to the position of the connecting piece 5 or the rocker pivot 26, the length of the pivotable guide piece 3 is approximately 15 to 25% of the inner circumference of the main pipe 11, to allow the cable 4 to be guided up to a cable conduit 15 that lies in the top area of the main pipe 11.

It can further be provided that the pivotable guide piece 3 is embodied as a cable coupler, with its end area that faces away from the adjoining guide piece 2 being displaceably guided on or in the cable conduit 15 or connected to it. In this case, the end of the additional guide piece 3 that is distant from the adjoining guide piece 2 can be inserted into a lateral continuous opening in the cable conduit 15, where it is then fed along by sliding. In this case, the pivotable guide piece 3 is also used to guide or support the collar A along the main pipe 11 up to the junction with the secondary pipe 12. For the translational movement of the collar A within the main pipe 11, a robot is ordinarily used.

The insertion of the collar A through a main pipe 11 into secondary pipes 12 that branch off at different angles will be detailed in reference to FIG. 7. In order to cover all possible installation types, two mirror-image collars A, A′ are necessary. For secondary pipes 12 that join with the main pipe 11 at a right angle, only one collar is necessary if it does not matter on which side of the junction the pivoting elements 5, 2, 6 [sic—Translator] are located. Otherwise, the conditions described in what follows for secondary pipes 12 that join with the main pipe 11 at different angles apply.

FIG. 7 shows two secondary pipes 12 and 12′, in which collars A, A′ according to the invention will be placed.

Viewing the left side of FIG. 7, it is apparent that collars A of the invention can be moved in two insertion directions, indicated by the arrows P1 and P2, through the main pipe 11 toward the acute angle 13 of the junction, in such a way that the pivoting elements 5, 26 are positioned upstream of the acute angle 13. With the collar A having the insertion direction indicated by arrow P1, the pivoting elements 5, 26, i.e., the connecting or bearing piece 5 or the rocker pivot 26, are moved toward the acute angle 13 and from this position, the collar A is pivoted into the final position indicated by dashed lines. The cable 4 is then drawn in afterward with respect to the circumferential edge 17 and the pivotable guide piece 3, or is guided outside of the collar A or is laid there. The cable 4 leading away from the adjoining guide piece 2 is drawn into the secondary pipe beforehand.

A corresponding subsequent running of the cable or subsequent drawing of the cable 4 accompanies the insertion of the collars A. During this running, the additional section 22 of the adjoining guide piece 2 lies either in the base area or in the top area of the main pipe 11 and is correspondingly positioned in the base area or in the top area of the secondary pipe 12. This positioning is made possible by the corresponding selection of the positioning or rotation of the collar A. In this manner, the cable 4 could be run in the base area or the top area of the main pipe 11 and also in the base or top area of the secondary pipe 12. The cable 4 is usually run in the top area of the main pipe 11, in particular, in a cable conduit 15.

If, as shown in FIG. 7, the collar A is moved in an insertion direction indicated by arrow P2 through the main pipe 11 toward the acute angle 13 of the junction, the same conditions with respect to the collar A apply as were described previously, i.e., the pivoting elements 5, 26 are moved toward the acute angle 13 or are positioned upstream of this, to allow the collar A to be pivoted into its final position while the pivoting elements 5, 26 or the guide piece 3 are held securely in place. The cable 4 that is laid in the main conduit can then exit at a corresponding point along a cable conduit that is laid in the main pipe and can be inserted into the pivotable guide piece 3. The cable to be run into the secondary pipe 12, however, has been guided around the outside of the collar A during movement of the collar A in the main pipe 11, in order to ensure free exit from the additional section 22 of the adjoining guide piece 2 once the collar A has been pivoted into its final position.

To permit the specified option of running the cable 4 in the base area or in the top area of the main pipe 11 and/or in the secondary pipe 12, mirror-image collars A, A′ are necessary, as shown in FIG. 7. Such mirror-image collars A, A′ are also necessary for always laying the cable 4, for example, in the top area of the main pipe 11 and in the base area of the secondary pipe 12, if the secondary pipes 12 have acute angles 13 that face the opposite direction with respect to the main pipe 11. Reference is made here to the right section of FIG. 7. In this section, a secondary pipe 12′ is shown, which will be equipped with a collar A′ in the insertion directions indicated by arrow P3 and arrow P4. Comparing the situations of the secondary pipes 12 and 12′, it is apparent that if it is necessary for the cable 4 to always be run in the top area of the main pipe 11 and in the base area of the secondary pipe 12 or 12′, regardless of the insertion direction, two different collars are necessary, specifically, mirror-image collars A, A′, as shown in the diagram of FIG. 7. The reason for this is the opposite inclination of the pipes 12, 12′, regardless of the actual angle formed by these pipes 12, 12′ with the main pipe 11.

When two mirror-image collars A and A′ are provided, the angle at which a secondary pipe 12, 12′ branches off from the main pipe 11, or the side wall surface of the main pipe 11 from which the secondary pipe 12, 12′ branches off, or whether it is desired to lay a cable above or below in the main pipe 11 or in the secondary pipe 12, 12′ is irrelevant. The only significant factor for insertion is that the pivoting elements 5, 26 can be moved toward the acute angle 13 between the main pipe 11 and the secondary pipe 12, 12′, or can be positioned upstream of this acute angle 13, and that the respective collar can be pivoted inward such that the additional section 22 of the adjoining guide piece 2 is pivoted into the interior of the secondary pipe 12, 12′ or is directed into this pipe.

When inserting the collars A, A′ into the junction area of the secondary pipes 12, 12′ it is not of particular importance from what direction the cable 4 laid in the main pipe 11 is run. For this reason, in FIG. 7 the cable running in the main pipe is shown fed in from both directions. It is important only that with insertion directions as indicated by arrows P2 and P3, i.e., from the obtuse side of the junction, the cable 4 must be guided outside of the collar and not through the collar.

In the inward pivoted position, the collar A is in a position in the secondary pipe 12 in which the edges 17, 18 of the collar body extend parallel to the circumference of the pipe. Following placement of the collar, the collar A can be expanded either via elastic forces or by inflating a balloon. In its final position, the band of the collar body 1 rests against the inside surface of the secondary pipe 12, wherein it is pressurized, which prevents the collar from sliding or being washed away. The rotation of the collar A along the circumference of the secondary pipe 12 is prevented by radial holding or adhesive forces directed outward.

It is provided that the collar A or the collar body 1, in particular, the entire unit, is positioned in the secondary pipe 12, wherein the circumferential edge 17 of the collar body 1 against which the adjoining guide piece 2 is fastened faces the main pipe 11. In this case it is provided that the first section 21 of the adjoining guide piece 2 and/or at least the area of the pivotable guide piece 3 that is near the connecting or bearing piece 5 or the rocker pivot 26 and/or the connecting or bearing piece 5 or the rocker pivot 26 is positioned in the area of or in front of the intersecting edge 13 of the main pipe 11 with the connecting secondary pipe 12.

1-15. (canceled)

16. A collar for laying cable in pipe systems, comprising:
a collar body having a first circumferential edge with a partial area and an opposite, second circumferential edge;
a first guide piece formed as a pipe with a guide opening for a cable, said first guide piece having a first section resting along and connected to said partial area of said circumferential edge of said collar body, said first guide piece having an additional section forming a continuation of said first section and being curved into an interior of the collar body, said additional section extending in a direction of said second circumferential edge of said collar body; and
a second guide piece formed with a guide opening for the cable, said second guide piece being pivotally mounted on said first section of said first guide piece.

17. The collar according to claim 16, wherein said second guide piece is a curved pipe.

18. The collar according to claim 16, wherein said additional section forming said continuation is curved onto an inner wall surface of said collar body.

19. The collar according to claim 18, wherein said additional section is attached to the inner wall surface of said collar body by gluing, welding, or fastening.

20. The collar according to claim 16, which comprises a connecting or bearing piece pivotally connecting an end of said first section to an end of said pivotable guide piece, or wherein the end of said first section and the end of said pivotable guide piece form a rocker pivot or are pivotally connected to one another with respect to a shared pivoting axis.

21. The collar according to claim 20, wherein said guide opening of said pivotable guide piece is a continuation of said guide opening of the adjoining said guide piece, said first section, said connecting or bearing piece, and said rocker pivot having a common cross-sectional area, and said first guide piece and said pivotable second guide piece delimit a continuous void for the cable, and wherein said first section of said first guide piece extends over an angle of 60° to 100° along said circumferential edge of said collar body, and said connecting or bearing piece or said rocker pivot and said additional section lie spaced from one another at a circumferential distance of 80° to 100° on said collar body, and wherein a pivoting axis between the adjoining said first guide piece and said second guide piece at a point of said connecting or bearing piece or said rocker pivot encloses an angle of ±10° with a tangent to a circumference of said collar body and/or to said circumferential edge.

22. The collar according to claim 21, wherein said first guide piece and said pivotable second guide piece are pipes having a common inner diameter.

23. The collar according to claim 21, wherein said first section of said first guide piece extends over an angle of 70° to 90° along said circumferential edge of said collar body, and said circumferential distance between said connecting or bearing piece or said rocker pivot and said additional section is 85° to 95°.

24. The collar according to claim 16, wherein:
said collar body is an elastically deformable band, curved along a longitudinal extent thereof, and split with free ends of said band overlapping one another;
one or both of said first guide piece and said second guide piece being a curved pipe, and said additional section of the adjoining said first guide piece extends perpendicular to said circumferential edges of said collar body in an area of an end facing away from said pivotable second guide piece.

25. The collar according to claim 16, wherein said band is curved to form a substantially circular collar body, and said additional section terminates flush with said circumferential edge or projects beyond said circumferential edge.

26. The collar according to claim 16, wherein said collar body is formed of a band having two ends that are displaceable relative to one another and connectible with one another, and wherein, when said two ends of said band of said collar body are connected, said first guide piece is positioned opposite to the connected two ends, wherein said collar body, in an area of said two ends, carries cooperating connecting elements and/or latching elements, or radially continuous openings and projections matching said openings, with which said two ends are connected to one another and a periphery of said collar body is secured.

27. A pipe system assembly, comprising:
a pipe system having a main pipe and at least one secondary pipe issuing into said main pipe at a junction;
a collar according to claim 16 disposed at said junction between said main pipe and said secondary pipe;
a cable guided, without interruption, from said main pipe through said collar into said secondary pipe, wherein said cable is guided through said first and second guide pieces and said connecting or bearing piece between said guide pieces and/or said rocker pivot.

28. The assembly according to claim 27, wherein said cable is secured in at least one of said first guide piece and said second guide piece.

29. The assembly according to claim 27, wherein:
said collar body is disposed in said secondary pipe and said circumferential edge of said collar body at which said first guide piece is fastened, faces said main pipe;
said first section of said second guide piece, or at least an area of said second guide piece that is near said connecting or bearing piece or said rocker pivot and/or said connecting or bearing piece or said rocker pivot are positioned in an area of or in front of an intersecting edge of said main pipe with said secondary pipe; and
wherein an outer wall of said collar body rests against an inner wall surface of said secondary pipe or is fastened or glued to said inner wall surface.

30. The assembly according to claim 27, wherein:
a length of a band forming said collar body corresponds to 50 to 150% of an inner circumference of said secondary pipe;
an outside of said collar body is coated with an adhesive material, which prevents at least one of an axial and a circumferential displacement of said collar body in said secondary pipe;
a curvature of said second guide piece substantially corresponds to a curvature of an inner cross-section of said main pipe; and
a length of said second guide piece is approximately 15 to 25% of an inner circumference of said main pipe.

31. The assembly according to claim 30, wherein said length of said band corresponds to 100 to 130% of the inner circumference of said secondary pipe.

32. The assembly according to claim 27, wherein:
a cable conduit is disposed in a top region of said main pipe, said cable is guided in said cable conduit and from said cable conduit in said second guide piece in an area of the junction with said secondary pipe;
said second guide piece is a cable coupler that is guided by an end area thereof that faces away from the adjoining guide piece so as to be displaceable on or in said cable conduit;
when a collar is inserted into said secondary pipe, said connecting or bearing piece or said rocker pivot are placed between said second guide piece and said first guide piece at a half height of said secondary pipe, and said additional section of said first guide piece extends in a base area of said secondary pipe.

33. A method for installing a cable in a pipe system, the pipe system having a main pipe and at least one secondary pipe joined to said main pipe, the method which comprises:
providing a collar according to claim 16;
inserting a cable into the first guide piece and the second guide piece of the collar;
inserting or drawing or forcing the cable that leads from the additional section through the main pipe into the secondary pipe;
inserting the collar through the main pipe until a circumferential edge with the connecting or bearing piece or the rocker pivot comes to rest at a front of the intersecting edge of an acute angle formed at a junction of the secondary pipe with the main pipe, and positioning the collar body in front of a junction opening of said secondary pipe;
with the second guide piece and/or the connecting or bearing piece near the first section held securely in place, substantially at a half height of the secondary pipe, pivoting the collar body, with the cable fed through it, in relation to the second guide piece, which is held stationary, and thereby inserting the collar into the secondary pipe; and
securing the collar in the secondary pipe.

34. The method according to claim 33, which comprises, before the collar is inserted into the main pipe, decreasing a circumference of the collar body and, once the collar body has been positioned at a desired location in the secondary pipe, enlarging the circumference of the collar body, by inflating an expansion balloon or unlocking a mechanical connection of two elastically expanding ends, thereby pressing a peripheral surface of the collar against the inner wall surface of the secondary pipe.

35. The method according to claim 34 which comprises gluing the collar body to the inner wall surface of the secondary pipe during or after the step of expanding the collar body.

36. The method according to claim 35, which comprises:
inserting the collar into the main pipe from a side of the acute angle of the junction of the secondary pipe, guiding the cable leading from the adjoining guide piece and to be guided into the secondary pipe in front of the collar body and subsequently inserting the cable that leads into the second guide piece into the main pipe;
when the collar body is inserted into the main pipe from the side of the obtuse angle of the junction of the secondary pipe, inserting the circumferential edge with the two guide pieces first in the direction of insertion and is laying or inserted first the cable leading from the additional section of the adjoining guide piece, outside of the collar body and/or past this, into the pipe, laying or guiding the cable leading from the pivotable guide piece in front in the direction of insertion, and wherein during insertion of the collar body, the pivotable guide piece functions as a cable coupler and is connected at its end that is distant from the collar to the cable conduit, and is displaced along or in the cable conduit positioned in the main pipe; and
wherein, during insertion of the collar in the main pipe and/or when pivoting the collar into the secondary pipe, the additional section of the adjoining guide piece is guided and/or positioned in the base area of the pipe.

37. The method according to claim 36, which comprises using mirror-image collars in secondary pipes branching off from the same side of the main pipe but in mutually different directions.
